(19) United States
(12) Patent Application Publication
(10) Pub. No.: US 2023/0166566 A1
(43) Pub. Date: Jun. 1, 2023

(54) PNEUMATIC TYRE

(71) Applicant: Apollo Tyres Global R&D B. V., Enschede (NL)

(72) Inventors: Martin GOOSSENS, Enschede (NL); Steven SCHULTZ, Enschede (NL); Gunasekaran DHANASEKARAN, Enschede (NL); Rosario ALESSIO, Enschede (NL)

(21) Appl. No.: 17/920,799

(22) PCT Filed: Apr. 21, 2021
(86) PCT No.: PCT/EP2021/060302

§ 371 Date: Oct. 23, 2022

(30) Foreign Application Priority Data
Apr. 24, 2020 (IN) 202011017609

(51) Int. Cl. B60C 19/00

(52) U.S. Cl. CPC B60C 19/002

(57) ABSTRACT

It is provided a pneumatic tyre (1) comprising: an inner surface (2), a tread portion (3), a pair of sidewall portions (4) radially inwardly extending from both edges of the tread portion (3), and bead portions (5) disposed at radially inner edges of the sidewall portions (4), and a sound absorbing device (6) made of a spongy material which is adhered to the inner surface (2) of the pneumatic tyre (1) at a tread region and extends in the tyre circumferential direction, wherein the sound absorbing device (6) comprises at least first and second sound absorbing members (7), wherein the at least first and second sound absorbing members (7) are separated from each other by a distance (S) in the axial tyre direction and are adhered to the inner surface (2) of the pneumatic tyre (1) by an adhesive component (8), wherein the adhesive component (8) comprises at least two annular- shaped adhesive beads (9) provided between each first and second sound absorbing member (7) and the inner surface (2) of the tyre (1), wherein the at least two adhesive beads (9) are arranged spaced apart from each other in the axial direction and extend in the circumferential direction of the tyre (1).

The present invention relates to a pneumatic tyre comprising a sound absorbing device.

In general, there are three sources of interior noise in a vehicle: the engine, the wind, and the vehicle tyres when the vehicle travels at a certain speed along a surface In modem vehicles, the engine and wind noise are largely reduced. Therefore, the relative contribution of the tyre is increasingly significant. One source contributing to the vehicle interior noise is the acoustical cavity mode inside the tyre, known in the art as tyre cavity noise.

The contact of the tyre with the road causes wave excitations inside the tyre-rim cavity. These acoustical waves travel in both positive and negative circumferential direction, and are called the forward and backward travelling wave, respectively. A standing wave pattern is formed when the wavelength exactly matches the cavity circumference. This is the so-called first acoustical cavity resonance mode and lies between 180 and 250 Hz for a passenger car tyre, dependent on both the tyre size as well as the tyre rotational speed. This acoustical cavity resonance mode is guided through the rim towards the spindle of the car body, resulting in vibrations and noise inside the vehicle.

Sound absorbing devices or noise dampers made of a spongy material disposed inside the tyre cavity to reduce cavity noise and as a consequence interior noise have been developed. U.S. 2019160890A1 describes a pneumatic tyre having a belt-shaped sound-absorbing member bonded via an adhesive layer to the tyre inner surface in a region corresponding to the tread portion along the tyre circumferential direction that has a width of 70% to 95% of a ground contact width of the tyre. The adhesive layer preferably is a double-sided adhesive tape having a thickness of 0.1 mm to 1.2 mm.

U.S. 20160297261 A1 describes a pneumatic tyre having a tread portion extending in the tyre circumferential direction having land portions defined between adjacent circumferential grooves of the tread portion, the tyre having first and second sound absorbing members adhered to the tyre inner surface of the tread portion which have a total volume of 10% to 40 % of a capacity of the tyre cavity and are separated from each other by 60% or more of the width of a center land portion.

EP 1253025 B1 describes a noise damper secured on a surface facing the cavity formed between a pneumatic tyre and a rim on which the tyre is mounted, where the noise damper is made of a porous material having a specific gravity of 0.005 to 0.06 and the volume of the noise damper being in a range of from 0.4% to 20% of the volume of the tyre cavity. The noise damper is fixed to the tire inside by an adhesive.

EP 1574360 B1 describes a noise damper for a pneumatic tyre comprising an annular body disposed in a tyre hollow, wherein the axial width of the annular body is constant or decreases gradually from the radially outer end towards the radially inner end, and wherein the annular body is made of a spongy material having a specific gravity of 0.005 to 0.06. The noise damper is fixed by applying an adhesive to the interface between the damper and tire either only partial or to the overall length of the damper.

EP 1876038 B2 describes an assembly of pneumatic tyre and rim, where a noise damper made of a spongy material is fixed to the inner surface of the pneumatic tyre at a tread region and extends in the tyre circumferential direction. The noise damper has a height of 30 mm or less from the inner surface, and the spongy material has a specific gravity of 0.014 to 0.05, a hardness of 10 to 250 N, and a tensile strength of 70 kPa or more. The noise damper is fixed to the inner surface by an adhesive layer such as an adhesive tape. It was found that cracking can occur in the vicinity of the adhesion surface at circumferential ends of the noise damper. The solution of preventing peeling and damages of the noise damper however was provided by specifying the height, hardness, tensile strength and specific gravity of the sponge material and the shape of the circumferential ends.

The present invention has the object to provide a sound absorbing device capable of reducing the low frequency interior noise between 180 to 250 Hz, while ensuring satisfactory endurance performance of the sound absorbing device and not impacting the high speed performance.

This object is achieved by a vehicle tyre comprising a sound absorbing device according to claim 1. Advantageous embodiments are the subject of the dependent claims. They may be combined freely unless the context clearly indicates otherwise.

Accordingly, a vehicle tyre is provided, the pneumatic tyre comprising:
an inner surface, a tread portion, a pair of sidewall portions radially inwardly extending from both edges of the tread portion, and bead portions disposed at radially inner edges of the sidewall portions, and
a sound absorbing device made of a spongy material which is adhered to the inner surface of the pneumatic tyre at a tread region and extends in the tyre circumferential direction,
wherein the sound absorbing device comprises at least first and second sound absorbing members, wherein the at least first and second sound absorbing members are separated from each other by a distance (S) in the axial tyre direction and are adhered to the inner surface of the pneumatic tyre by an adhesive component, wherein the adhesive component comprises at least two annular-shaped adhesive beads provided between each first and second sound absorbing member and the inner surface of the tyre, wherein the at least two adhesive beads are arranged spaced apart from each other in the axial direction and extend in the circumferential direction of the tyre.

The sound absorbing members are fixed to the inner surface of the tyre by at least two annular-shaped adhesive beads. Preferably, each member is glued to the tyre’s inner liner with just two glue beads. Adhesion via such beads was found to prevent internal stresses in lateral direction in the spongy material of the sound absorbing members. It is assumed that this due to an improved ability of the spongy material to follow the tyre’s contour compared to being fixed to the inner surface over the full surface. This allows for the spongy material, such as an open cell foam, to survive tyre deformations easily. Particularly it was found that adhering at least two sound absorbing strips of foam with multiple glue beads resulted in a significant reduction in stresses inside the sound absorbing foam in a bending stress test compared to a single sound absorbing member adhered with multiple glue beads.

The sound absorbing device comprises at least first and second sound absorbing members. It was found that at least two sound absorbing members provide for better noise performance, particularly for an improvement in the interior noise of the driving cabin, of a tyre equipped therewith compared to a single sound absorbing device of even 20% higher volume of sound absorbing foam. The sound absorbing device may comprise a plurality of sound absorbing members, such as three, four, six, eight or ten sound absorbing members. In embodiments, where a plurality of sound absorbing members is provided, each gap between the ends of the corresponding sound absorbing member may be displaced by a circumferential distance (D) between the gaps of preferably at least 10% of the circumferential extent of the tyre.

The adhesive component is provided between the inner surface of the tyre and the sound absorbing members. The adhesive component comprises at least two spaced apart annular-shaped adhesive beads to adhere each sound absorbing member to the inner surface of the tyre. The adhesive component may comprise annular-shaped adhesive beads extending continuously along the inner surface in the circumferential direction of the tyre. In such embodiments, the adhesive component may comprise at least four axially spaced annular-shaped adhesive beads. This may simplify the application of glue beads. In other embodiments, all single sound absorbing members may be adhered to the tyre’s inner liner with two separated glue beads. The adhesive component thus may comprise a plurality of axially spaced annular-shaped adhesive beads. In such embodiment, the adhesive component may comprise four, six, eight, 12 or 16 adhesive beads.

The adhesive beads preferably are formed as glue beads. In embodiments, each adhesive bead has a width (Wa) in the axial direction in a range of from 4 mm to 15 mm, preferably of from 8 mm to 10 mm, and a height (Ha) in the radial direction in a range of from 0.5 mm to 4 mm, preferably of from 1 mm to 2 mm. It is understood, that these dimensions refer to the adhesive beads, such as glue beads, when applied to the inner surface, e.g. before being distorted by pressing the sound absorbing members to the adhesive bead. It was found that these dimensions provide for an optimum balance between adhesion performance and the weight added by the glue. Particularly, these dimensions of the glue beads can provide for an optimum glue thickness for best adhesion performance. Usable glues are commercially available. Preferred glues are for example glues available under the tradename Loctite® from Henkel, such as Loctite® SI 5930 FIT.

The sound absorbing members are made of a spongy material. The term “spongy material” refers to a sponge-like porous material, such as open-cell polyurethane foams. These materials are known to lower the volume of sound by converting vibration energy into heat energy. Examples of the spongy material are a sponge-like porous materials made of a synthetic resin such as an ether-based polyurethane foam, an ester-based polyurethane foam or a polyethylene foam, a foam of a rubber such as a chloroprene rubber foam, an ethylenepropylene rubber foam or a nitrile rubber foam. Polyurethane foams particularly ether-based polyurethane foams are preferred. The polyurethane foams can be a poly-addition product of isocyanates, polyether/ polyester polyols and water, controlled by catalysts, stabilizers and other additives, resulting in a cellular polyurethane foam.

In embodiments, the spongy material of the sound absorbing members comprises a polyurethane foam material having:
a specific gravity in a range of from 0.022 to 0.032, preferably of from 0.026 to 0.030, and/or
of from 10 to 25 pores per cm, preferable 15 +/- 2 pores per cm, and/or
a permanent compression set of <10% (measured according to NF EN ISO 1856).

The term “specific gravity” refers the density of a material at a temperature of 20° C. divided by the density of water at that temperature, which is approximately 998 kg/m³.

The polyurethane foam material may have a density of from 20 kg/m³ to 30 kg/m³, preferably of from 26 kg/m³ to 30 kg/m³ measured according to DIN EN ISO 845. The polyurethane foam material may have a density of 23 +/- 2 kg/m³ or of 28 +/- 2 kg/m³. The polyurethane foam material comprises cells where the cells may have an average size ranging from 250 µm to 400 µm with a standard deviation ranging from 20% to 30%. The polyurethane foam material may have a permanent compression set of <10%, preferably of <7% measured according to DIN EN ISO 1856 (22 h, 50%, 70° C.). Usable polyurethane foam materials are commercially available. Preferred polyurethane foam materials are for example available from Metzeler Schaum GmbH under the tradename Metzonor^{®} MA 3031D, 023 and available from Masterfoam MT28FX. Preferred are open-cell Metzeler Metzonor^{®} 023 or Metzonor^{®} MA 3031D foams with a density of 23 +/- 2 kg/m³ or 28 +/- 2 kg/m³, respectively. These foams provide for optimum noise performance.

The sound absorbing members are separated from each other by a distance (S) in the axial tyre direction. The distance (S) may cover a part of the inner surface corresponding to the central tread portion, particularly at least a part of the surface of a center rib in the outer tread portion. In embodiments, the first and second sound absorbing members are axially spaced by a distance (S) of from 10 mm to 20 mm, preferably of from 10 mm to 15 mm. For a tyre comprising circumferencial grooves defining a central land portion with a circumferential center rib, such a distance may correspond to 40% to 60% of the width of the tyre’s center rib. Keeping the inner side of the tyre at least partially free of sound absorbing foam members results in less heat build-up in this area and improves significantly the high speed test results, for example for summer tyres. Usually, the area around a tyre meridian plane sees heat build-up. It is within the knowledge of the skilled person to define such a distance (S) for tyres having a central groove, slant grooves, V-shaped grooves or winding grooves, for example. Preventing heating up of the tyre’s center rib provides for a better durability performance. It could be shown that using two sound absorbing members axially spaced by a distance (S) of 20 mm or less significantly improved the high speed performance. It is assumed that this is a result of lesser heat buildup especially in the tread portion around the tyre equatorial plane.

The first and second sound absorbing members preferably are shaped in a substantially ring form. In embodiments, the first and second sound absorbing members have a rectangular cross section having a height (Hs) in the radial direction from the inner surface, a width (Ws) in the axial direction and a length (Ls) in the circumferential direction thereby defining for each member circumferential outer ends, wherein the height (Hs) of the sound absorbing members is in a range of 20 mm ≤ Hs ≤ 40 mm, preferably of 30 mm < Hs ≤ 33 mm. A height of the sound absorbing members in such a range can provide for optimum noise performance. The height Hs is measured in the direction perpendicular to the inner surface with respect to a sound absorbing member fixed to the tyre in the state prior to mounting the tyre on a rim under ordinary temperature and ordinary pressure.

In embodiments, the width (Ws) of the sound absorbing members is of from 30 mm ≤ Ws ≤ 70 mm, preferably of from 40 mm ≤ Ws ≤ 60 mm. A width of the sound absorbing members in such a range can provide for optimum noise performance. The width Ws may be for example 40 mm, 45 mm, 50 mm, 55 mm, 60 mm, 65 mm, or 70 mm.

In embodiments, the circumferential outer ends of the first and second sound absorbing members provide a gap (G) of from 1% to 5%, preferably of from 1% to 2%, of the circumference of the tyre, based on 100% total circumference. Thus, in these embodiments a sound absorbing member covers 98-99% of the circumference of the tyre. Such a gap provides that the inner side of the tyre’s center rib is free of absorbing members or foam. A gap in these dimensions may correspond to a gap (G) of 50 mm or less in the circumferential direction of a passenger tyre. A gap of 50 mm or less can provide for maintained noise performance with satisfactory endurance performance and does not impact the high speed performance.

In embodiments, the circumferential outer ends of the first and second sound absorbing members are substantially devoid of a taper. The sound absorbing members being substantially devoid of a taper can provide a better durability performance.

In embodiments, the sound absorbing device has a volume (Vs) in a range of from 6% to 18% of the total volume (Vc) of the tyre cavity. The volume Vs of the sound absorbing device is an apparent whole volume and denotes a volume defined by the outward form of the sound absorbing device including the pores or cells inside the sound absorbing device. The volume Vc of the tyre cavity is determined with respect to an assembly in the normal state where a normal internal pressure and no load are applied to the assembly, based on the cross sectional area of the cavity, the maximum outer diameter of the cavity, the diameter of the rim, and the ratio of the circumference of a circle to its diameter. The sound absorbing device having a volume of from 6% to 18% of the total volume of the tyre cavity provides for optimum noise performance.

In embodiments, the inner surface of the tyre is substantially devoid of silicone-based release agents and/or polytetrafluoroethylene (PTFE)-based release agents. Avoiding a use of usual release agents, usually denoted “bladder paint”, will improve the adhesion performance between the foam of the sound absorbing device and the adhesive beads. Preferred release agents or so-called bladder paints are for example available from Lanxess Rhein Chemie under the tradename Rhenodiv® BP-166 or Rhenodiv® BP-9500.

Instead of usual silicone-based release agents a permanently coated bladder and/or non-silicone or non-PTFE based release agents may be used for vulcanizing the tyres. It provides an advantage that the silicone-based or PTFE-based release agents are not present. The preferred permanently coated bladders and/or release agents not comprising silicone or PTFE improves the adhesion between the adhesive beads and the tyre.

A further aspect relates to a wheel assembly comprising a pneumatic tyre according to the invention assembled onto a wheel. For the description of the pneumatic tyre reference is made to description of the tyre above.

A further aspect relates to a method of preparing a tyre according to the invention, comprising the steps of:
providing a tyre assembly comprising a mold for defining a shape of an outer wall of the tyre after vulcanizing-molding and a bladder for pressing an inner wall of a green tyre towards the mold during vulcanizing-molding, and providing in the mold a green tyre comprising an inner surface;
vulcanizing the green tyre in the tyre assembly by pressing the bladder against the inner surface;
providing an adhesive for adhering the sound absorbing device to the inner surface;
applying at least two annular-shaped adhesive beads onto the inner surface;
providing a sound absorbing device comprising at least first and second sound absorbing members made of a spongy material to be adhered onto the inner surface; and
placing the at least first and second sound absorbing members onto the adhesive beads and pressing so as to contact the sound absorbing device with the inner surface.

In embodiments of the method, the green tyre is vulcanized using a permanently coated bladder or a bladder coated with a non-silicone or non polytetrafluoroethylene (PTFE) based release agent. In further embodiments of the method, the green tyre is vulcanized using a permanently coated bladder and a bladder coated with a non-silicone or non polytetrafluoroethylene (PTFE) based release agent. Either a permanently coated bladder without using bladder paint, or non-silicone based release agents or non PTFE-based release agent will provide good adhesion between the glue beads and tyre’s inner liner without the need of cleaning the inner liner first.

For the description of the tyre assembly, bladder and release agents reference is made to description above. Preferred release agents are for example available from Lanxess Rhein Chemie under the tradename Rhenodiv® BP-166 or Rhenodiv® BP-9500.

In the following the invention is explained in detail by examples and with reference to the enclosed drawings showing preferred embodiments of the present invention, wherein each feature can constitute solely or in combination an aspect of the invention.

In the drawings:

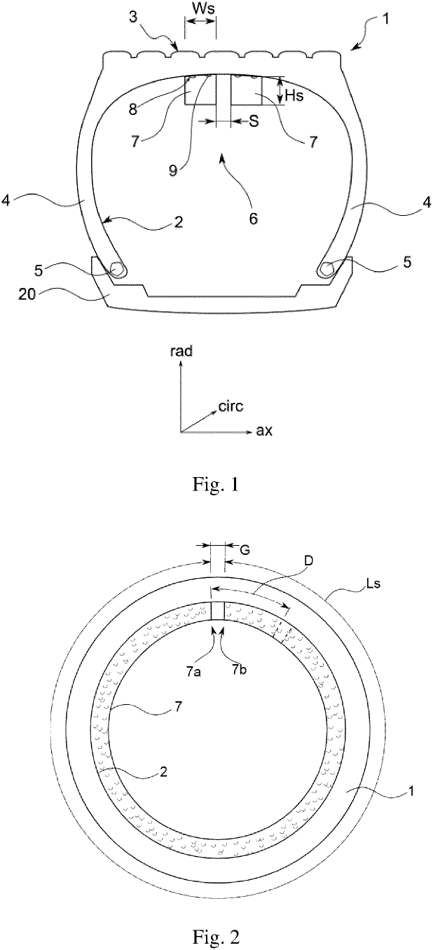

FIG. 1 schematically shows a wheel assembly comprising a pneumatic tyre according to one embodiment of the invention assembled onto a wheel.

FIG. 2 schematically shows an equator cross-sectional view of the pneumatic tyre according to the embodiment of FIG. 1.

As shown in FIG. 1, a wheel assembly comprises a pneumatic tyre 1 assembled onto a wheel 20. The pneumatic tyre 1 comprises an inner surface 2, a tread portion 3, and a pair of sidewall portions 4 radially inwardly extending from both edges of the tread portion 3. Bead portions 5 are disposed at radially inner edges of the sidewall portions 4. A sound absorbing device 6 made of a spongy material is adhered to the inner surface 2 of the pneumatic tyre 1 at a tread region and extends in the tyre circumferential direction. The sound absorbing device 6 comprises first and second sound absorbing members 7, wherein the sound absorbing members 7 are separated from each other by a distance S in the axial tyre direction. The distance S may be of from 10 mm to 20 mm, such as 15 mm in a passenger tyre. The sound absorbing members 7 have a rectangular cross section having a height Hs in the radial direction from the inner surface 2, a width Ws in the axial direction and a length Ls in the circumferential direction. The height Hs may be 30 mm < Hs < 33 mm. The width Ws may be 30 mm ≤ Ws ≤ 70 mm, such as 40 mm, 45 mm, 50 mm, 55 mm, 60 mm, 65 mm, or 70 mm.

The sound absorbing members 7 are adhered to the inner surface 2 of the pneumatic tyre 1 by an adhesive component 8. The adhesive component 8 comprises two annular-shaped adhesive beads 9 which are provided between each of the sound absorbing members 7 and the inner surface 2 of the tyre 1. The two adhesive beads 9 are arranged spaced apart from each other in the axial direction and extend in the circumferential direction of the tyre 1.

FIG. 2 illustrates an equator cross-sectional view of the pneumatic tyre according to the embodiment of FIG. 1. The sound absorbing members further have a length Ls in the circumferential direction thereby defining circumferential outer ends 7a, 7b. The circumferential outer ends 7a, 7b of the first and second sound absorbing members 7 provide a gap G of from 1% to 2% of the circumference of the tyre, based on 100% total circumference. Preferably, the circumferential outer ends 7a, 7b of the first and second sound absorbing members 7 are substantially devoid of a taper. When a plurality of sound absorbing members is provided, each gap G between the ends of the corresponding sound absorbing member may be displaced by a circumferential distance D between the gaps of preferably at least 10% of the circumferential extent of the tyre. The displacement D may be used in compensating a possible reduction of uniformity of the vulcanized tyre after vulcanization. The displacement may support maintaining endurance performance and high speed performance.

Examples of the present invention will be described below, but the present invention is not limited to the following examples.

### EXAMPLE 1: INTERIOR NOISE TESTS

Prototypes of tyres equipped with a sound absorbing device component were compared to a reference tyre. A set of inventive example E1 tyres were built having two sound absorbing members applied to the inner-liner of a 245/45R18 UHP summer tyre. The reference Ref 1 tyres were built having a sound absorbing component with one single sound absorbing member applied to the inner liner of a 245/45R18 UHP summer tyre.

The tyres were tested in an indoor test facility on a test machine with a rotating drum. One drum is used simultaneously driving both rear tyres. Only the rear-left tyre is changed between the tests. The rear right tyre is devoid of a sound absorbing device and is used as control tyre. A relative smooth surface of the drum was used. Both a coast-down of 145 - 20 km/h and three constant speed measurements (120, 80 and 60 km/h) were carried out. Resulting vibrations were measured with an accelerometer at the hub.

Noise levels inside the car were measured with a microphone. Also microphones were placed at outside locations to measure exterior noise. Measurement values are for the vibrations of the hub in x-, y- and z- direction, and the sound pressure levels.

The Close Proximity (CPX) method, standardized in ISO/DIS 11819-2, is used as the measurement method for tyre/road noise. The CPX method includes the measurement of the A-weighted sound pressure level generated by the tyre/road interaction over a specified road distance using at least two microphones in the vicinity of the reference tire. A-weighting is a standard method for altering the sound pressure levels recorded by a microphone to closely match the perception of the human ear.

The CPX setup is as follows. Two microphones are located on the side of the vehicle at a height of 10 cm above the road and a distance of 20 cm measured in the axial direction from the plane of the undeflected sidewall. A first front microphone is placed at a distance of 20 cm in a vehicle front direction from a target plane (CPX-Front). A rear microphone is placed at a distance of 20 cm measured in a vehicle rear direction from the target plane (CPX-Rear). The target plane is the plane containing the tyre axis and the tyre-road contact center-point.

The results and configuration details of the “Ref 1” as well as the inventive example “E1” are given in the Table 1 below. The peak reduction is the cavity noise peak reduction in the frequency range between 180 and 250 Hz at driver’s left ear position at 80 km/h.

TABLE 1

Indoor measurements

| | Ref 1 | E1 |
|---|---|---|
| # sound absorbing members | 1 | 2 |
| # of glue beads | 4 | 4 |
| Hs (mm) | 30 | 30 |
| Ws (mm) | 120 | 50 |
| S (mm) | - | 20 |
| G (mm) | 50 | 30 |
| Foam density (+/- 2 kg/m3) | 23 | 23 |
| Peak reduction ( dB(A) ) | 9.4 | 12.7 |

The two sound absorbing members in inventive example “E1” effectively reduce the tyre cavity noise, even more efficient than a concept with 20% higher volume of foam.

### EXAMPLE 2: HIGH SPEED TESTS

All high speed tests were performed on prototype 245/45R18 UHP summer tyres. A set of inventive example E2 tyres were built having two sound absorbing members applied to the inner-liner of a 245/45R18 UHP summer tyre. Two reference tyres were built and used in the high speed tests. A first set Ref 2 of reference tyres were built having no sound absorbing component. A second set Ref 3 of reference tyres were built having one single sound absorbing member applied to the inner liner of a 245/45R18 UHP summer tyre.

The high speed test is a destructive test procedure measuring the total running time before failure of a tyre rotating against a drum. A Y rated tyre must pass the legal lower limit of 60 minutes running time according to the speed ramp up shown in Table 2. Table 2 displays the speed ramp used during a high speed test for a Y rated tyre. In Table 2, the running time is the time interval at the given speed, while total time is the accumulated duration of the test at the end of each interval. Table 3 shows the configuration of the prototype tyres and the results of the high speed test.

TABLE 2

Speed ramp for a Y rated tyre

| Speed | Running Time (minutes) | Total test time (minutes) |
|---|---|---|
| 260 | 10 | 10 |
| 270 | 20 | 30 |
| 280 | 10 | 40 |
| 290 | 10 | 50 |
| 300 | 10 | 60 |
| 310 | 10 | 70 |
| 320 | 10 | 80 |
| 330 | 10 | 90 |
| 340 | 10 | 100 |

TABLE 3

Total running time at high speed

| | Ref 2 | Ref 3 | E2 |
|---|---|---|---|
| # sound absorbing members | - | 1 | 2 |
| # of glue beads | - | 4 | 4 |
| Hs (mm) | - | 30 | 30 |
| Ws (mm) | - | 120 | 50 |
| G (mm) | - | 12 | 30 |
| S (mm) | - | - | 20 |
| Foam density (+/- 2 kg/m3) | 23 | 23 | 23 |
| Test duration (minutes) | 87 | 58 | 83 |

The tests results reported in Table 3 show that a sound absorbing component comprising a single sound absorbing member according to the “Ref 3” tyres significantly deteriorates the high speed performance due to more heat buildup, especially in the tread portion around the tyre equatorial plane. Results in Table 3 show a similar high speed performance of “Ref 2” tyres without a sound absorbing component and the inventive example “E2” tyres.

### EXAMPLE 3: ENDURANCE TESTS

The endurance test is a destructive indoor test measuring distance to failure. The test speed is 120 km/h. The test is ended at a survival distance of 30,000 km. Measurement is the total kilometers of running on a drum before tyre and/or foam failure.

Three sets of prototype tyres were built. Namely, a first set Ref 4 having 245/45R18 100Y UHP All Season tyres, a second set Ref 5 of 245/45R18 96W high performance tyres and a third inventive set E3 of 245/45R18 100Y UHP All Season tyres. All tyre sets were configured as shown in Table 4 having a sound absorbing device component.

TABLE 4

Endurance measurements

| | | | |
|---|---|---|---|
| | Ref 4 | Ref 5 | E3 |
| # sound absorbing members | 1 | 1 | 2 |
| # of glue beads | 4 | 4 | 4 |
| Hs (mm) | 30 | 30 | 30 |
| Ws (mm) | 120 | 100 | 50 |
| S (mm) | - | - | 20 |
| G (mm) | 50 | 0 | 30 |
| Foam density (kg/m3) | 23 +/- 2 | 20 - 30 | 23 +/- 2 |
| 16.800 km | NOK | NOK | OK |
| 30.000 km | - | - | OK |

“Ref 4” from Table 4 showed mixed results on foam adhesion but major failures after 16,800 km. “Ref 5” from Table 4 showed complete foam detachment after 16,800 km.

The inventive example “E3” tyre s reached the end of the test (30,000 km) with good result on endurance performance for the tyre and the adhesive interface.

### EXAMPLE 4: BENDING TESTS

Two new sets of prototype tyres were built. Namely, a set of inventive example E4 245/45R18 100Y UHP All Season tyres and a set of inventive example set E5 of 235/55R19 (101Y) UHP summer tyres. Inventive examples “E4” and “E5” were configured having a sound absorbing device component with two sound absorbing members. The length of the sound absorbing member provides for an extent of 98% to 99% of the tyre circumference. The gap between the ends of the corresponding sound absorbing members was displaced by a circumferential distance D of about 10% of the circumferential extent of the tyre, also compensating uniformity values for the tyres. The Ref 1 tyres and the inventive E1 tyres were also included in the subjective bend test.

The sound absorbing members were made of a spongy material. The spongy material was a foam produced by Metzeler Schaum GmbH. The adhesive component in the inventive examples was configured having two beads of adhesive material per sound absorbing member. The adhesive material was a Loctite SI 5930 FIT provided by Henkel. The width Wb of the adhesive beads was between 8 and 9 mm. Each bead was configured having different circumferential positions for the starting point of each bead application. Tyres were vulcanized in a vulcanizing press having a permanently coated bladder without bladder paint.

A test of internal bending stress was made by examining the shape of the glue beads for a tyre cross section given a simple bending test. Bending a tyre with one single sound absorbing member adhered with multiple glue beads results in visible stresses inside the foam, resulting in a less durable concept. Bending a tyre with two strips of foam with a small spacing in between did not result in significant stresses inside the foam.

TABLE 5

Subjective bend test example

| | | | | |
|---|---|---|---|---|
| | Ref 1 | E1 | E4 | E5 |
| # sound absorbing members | 1 | 2 | 2 | 2 |
| # of glue beads | 4 | 4 | 4 | 4 |
| Hs (mm) | 30 | 30 | 31 | 31 |
| Ws (mm) | 120 | 50 | 50 | 50 |
| S (mm) | - | 20 | 15 | 15 |
| G (mm) | 50 | 30 | 30 | 30 |
| Foam density (kg/m3) | 23 | 23 | 28 | 28 |
| Subjective bending test | NOK | OK | OK | OK |

Reference signs:

| | |
|---|---|
| 1 | tyre |
| 2 | tyre inner surface |
| 3 | tread portion |
| 4 | sidewall portion |
| 5 | bead portion |
| 6 | sound absorbing device |
| 7 | sound absorbing member |
| 7a,7b | outer ends of sound absorbing members |
| 8 | adhesive component |
| 9 | adhesive bead |
| 20 | wheel |
| Hs | height of sound absorbing member |
| Ws | width of sound absorbing member |
| Ls | length of sound absorbing member |
| G | gap between circumferential outer ends |
| Ha | height of adhesive bead |
| Wa | width of adhesive bead |
| Vc | volume of tyre cavity |
| Vs | volume of sound absorbing member |
| S | axial spacing of sound absorbing members |
| D | circumferential distance between the gaps G |

1. A pneumatic tyre comprising: an inner surface, a tread portion, a pair of sidewall portions radially inwardly extending from both edges of the tread portion, and bead portions disposed at radially inner edges of the sidewall portions, and a sound absorbing device made of a spongy material which is adhered to the inner surface of the pneumatic tyre at a tread region and extends in the tyre circumferential direction, wherein the sound absorbing device comprises at least first and second sound absorbing members, wherein the at least first and second sound absorbing members are separated from each other by a distance in the axial tyre direction and are adhered to the inner surface of the pneumatic tyre by an adhesive component, characterized in that the adhesive component comprises at least two annular shaped adhesive beads provided between each first and second sound absorbing member and the inner surface of the tyre, wherein the at least two adhesive beads are arranged spaced apart from each other in the axial direction and extend in the circumferential direction of the tyre.

2. The tyre according to claim 1, wherein each adhesive bead has a width (Wa) in the axial direction in a range of from 4 mm to 15 mm, and a height (Ha) in the radial direction in a range of from 0.5 mm to 4 mm.

3. The tyre according to claim 1, wherein the spongy material of the sound absorbing members comprises a polyurethane foam material having:
a specific gravity in a range of from 0.022 to 0.032, or
of from 10 to 25 pores per cm, or
a permanent compression set of <10% (measured according to NF EN ISO 1856).

4. The tyre according to claim 1, wherein the first and second sound absorbing members are axially spaced by a distance (S) of from 10 mm to 20 mm.

5. The tyre according to claim 1, wherein the first and second sound absorbing members have a rectangular cross section having a height (Hs) in the radial direction from the inner surface, a width (Ws) in the axial direction and a length in the circumferential direction thereby defining for each member circumferential outer ends, wherein the height (Hs) of the sound absorbing members is in a range of 20 mm < Hs < 40 mm.

6. The tyre according to claim 1, wherein the width (Ws) of the sound absorbing members is of from 30 mm < Ws < 70 mm.

7. The tyre according to claim 1, wherein the circumferential outer ends of the first and second sound absorbing members provide a gap (G) of from 1 % to 5 % of the circumference of the tyre, based on 100% total circumference.

8. The tyre according to claim 1, wherein the circumferential outer ends of the first and second sound absorbing members are substantially devoid of a taper.

9. The tyre according to claim 1, wherein the sound absorbing device has a volume (Vs) in a range of from 6% to 18% of the total volume (Vc) of the tyre cavity.

10. The tyre according to claim 1, wherein the inner surface of the tyre is substantially devoid of silicone-based release agents and polytetrafluoroethylene (PTFE)-based release agents.

11. A wheel assembly comprising a pneumatic tyre assembled onto a wheel, characterized in that the tyre is a tyre according to claim 1.

12. A method of preparing a pneumatic tyre according to claim 1, comprising the steps of:
- providing a tyre assembly comprising a mold for defining a shape of an outer wall of the tyre after vulcanizing-molding and a bladder for pressing an inner wall of a green tyre towards the mold during vulcanizing-molding, and providing in the mold a green tyre comprising an inner surface;
- vulcanizing the green tyre in the tyre assembly by pressing the bladder against the inner surface;
- providing an adhesive for adhering the sound absorbing device to the inner surface;
- applying at least two annular- shaped adhesive beads onto the inner surface ; - providing a sound absorbing device comprising at least first and second sound absorbing members made of a spongy material to be adhered onto the inner surface ; and
- placing the at least first and second sound absorbing members onto the adhesive beads and pressing so as to contact the sound absorbing device with the inner surface.

13. The method according to claim 12, wherein the green tyre is vulcanized using a permanently coated bladder or a bladder coated with a non-silicone or non polytetrafluoroethylene (PTFE) based release agent.

14. The method according to claim 12, wherein the green tyre is vulcanized using a permanently coated bladder and a bladder coated with a non-silicone or non polytetrafluoroethylene (PTFE) based release agent.
